(19) United States
(12) Patent Application Publication
(10) Pub. No.: US 2006/0107323 A1
(43) Pub. Date: May 18, 2006

(54) System and method for using a dynamic credential to identify a cloned device

(76) Inventor: Ivan Hugh McLean, Solana Beach, CA (US)

Correspondence Address: QUALCOMM, INC, 5775 MOREHOUSE DR., SAN DIEGO, CA, 92121, US

(21) Appl. No.: 10/990,683

(22) Filed: Nov. 16, 2004

(51) Int. Cl. G06F 12/14

(52) U.S. Cl. 726/23

(57) ABSTRACT

A system and method for providing secure communications between client communication devices and servers. A server generates a random offset. The server alters a server communication device dynamic credential by applying the random offset to the server communication device dynamic credential. The server stores the server communication device dynamic credential. The server sends, via a network, a signal including the random offset. The server receives, via a network, a signal including a dynamic credential. The server determines a difference between the server communication device dynamic credential and the received dynamic credential. In addition, the server detects a presence of a cloned communications device based on the difference.

### BACKGROUND

I. Field

The present invention generally relates to preserving secure communications between networked devices. More particularly, the invention relates to preserving secure communications between such devices using automatic detection techniques to identify the presence of a cloned device.

II. Background

Advances in technology have resulted in smaller and more powerful personal computing devices. For example, there currently exist a variety of portable personal computing devices, including wireless computing devices, such as portable wireless telephones, personal digital assistants (PDAs), and paging devices that are each small, lightweight, and can be easily carried by users. More specifically, the portable wireless telephones, for example, further include cellular telephones that communicate voice and data packets over wireless networks. Further, many such cellular telephones are being manufactured with relatively large increases in computing capabilities, and as such, are becoming tantamount to small personal computers and hand-held PDAs. Typically, these smaller and more powerful personal computing devices are severely resource constrained. For example, the screen size, amount of available memory and file system space, amount of input and output capabilities and processing capability may be each limited by the small size of the device. Because of such severe resource constraints, it is often typically desirable, for example, to maintain a limited size and quantity of software applications and other information residing on such personal computing devices (client communication devices).

Some of these personal computing devices utilize application programming interfaces (“APIs”), sometimes referred to as runtime environments and software platforms, that are installed onto their local computer platform and which are used, for example, to simplify operation of such devices, such as by providing generalized calls for device specific resources. Further, some such APIs are also known to provide software developers the ability to create software applications that are fully executable on such devices. In addition, often such APIs are known to be operationally located between the computing device system software and the software applications such that the computing device computing functionality is made available to the software applications without requiring the software developer to have the specific computing device system source code. Further, some like APIs are known to provide mechanisms for secure communications between such personal devices (i.e., clients) and remote devices (i.e., servers) using secret credentials.

Examples of such an APIs, some of which are discussed in more detail below, include those currently publicly available versions of the Binary Runtime Environment for Wireless® (BREW®) developed by Qualcomm, Inc., of San Diego, Calif. BREW® is sometimes described as a thin veneer existing over a computing device's (typically a wireless cellular phone) operating system, which, among other features, provides interfaces to hardware features particularly found on personal computing devices. BREW® is further characterized by, at least, the one advantage of being able to be provided on such personal computing devices at a relatively low cost with respect to demands on such device resources and with respect to the price paid by consumers for devices containing the BREW® API. Other features known to be associated with BREW® include its end-to-end software distribution platform that provides a variety of benefits for wireless service operators, software developers and computing device consumers. At least one such currently available end-to-end software distribution platform includes logic distributed over a server-client architecture, where the server performs, for example, billing, security and application distribution functionality, and the client performs, for example, application execution, security and user interface functionality.

Regarding providing secure communication between networked devices, such as between networked clients and servers, many systems typically achieve such secure communications, in part, by including secret information (e.g., one or more credentials) in a transmission sent from an origination device (e.g., a client communication device) to a destination device (e.g., a server). Here, the destination device authenticates the transmission by comparing at least a portion of the secret information sent in the transmission with a corresponding version of such secret information accessible to the destination device. Furthermore, many such systems encrypt the secret using a public encryption algorithm that is generally not kept in secret. Although in many systems the secret information sent only includes a single secret term, other systems may provide multiple secrets as the secret information.

Unfortunately such systems that use secret information to provide secure communications are typically unable to discern between any two devices providing the same secret. As such, such systems are generally vulnerable to rogue client devices that are able to spoof other valid client devices by falsely identifying themselves as the valid client device by providing the valid secret information used to identify the valid client device. Therefore, such rogue client devices need only capture the secret information once, by either snooping the communications from the valid client device or by mounting an attack on either the client or the server device, or by other means which would allow the rogue client device to capture the secret information of the valid client device.

One example of a system for providing secure communications are those systems that utilize one-time password schemes where, for example, a client device is programmed, or is otherwise assigned, a seed value where a one-time password is then generated on the fly from the seed value. Such one-time password is then also provided to a corresponding server such that the server can identify transmission from the client device by matching a one-time password within a transmission to the one-time password associated with the particular client device. At least some of such systems utilize a common algorithm at both the client and server to create and validate the one-time password sent in the transmission signal. Although client devices utilizing one-time password schemes typically provide significant protection against snooping attacks, such client devices typically provide ineffective spoofing protection when the client device itself is compromised, and there is typically no ability to recover in circumstances where the server itself is compromised.

Another example of a system for providing secure communications are those systems that use challenge response protocols together with the use of short lived (ephemeral) keys to achieve secure communications. Such systems typically require the sending of multiple round trip signals (i.e., requiring multiple send and receive signal pairs) to achieve the desired secure communication functionality. This use of multiple round trips is known to require servers to maintain state information that associates a first round trip with a subsequent round trip. This use of multiple round trip signals provides a disadvantage in the resulting inherent costs of the generation, transmission, reception and processing of such multiple signals. Another disadvantage is all of the overhead and costs associated with maintaining state information at the server to handle such multiple round trip schemes. Other such challenge response protocols are able to achieve the desired secure communications functionality in a single round trip, but must do so by initiating such a transaction at the server device rather than the client device.

Accordingly it would be advantageous to provide secure communication system for networked devices that includes the ability to detect the cloning or spoofing of authorized devices, such as those associated with the use of one-time password schemes or challenge response protocols, while also avoiding other less advantageous aspects of such existing systems. Such less advantageous aspects of existing systems including generally, for example, the relatively expense processing requirements often used in such systems, as well as more specifically, for example, problems such as those associated with use of one-time password schemes including not allowing for the ability to recover once the password is compromised, or those problems associated with challenge response protocol schemes such as the use of multiple roundtrip signals, the use of server state information, and the use of server initiated signals.

### SUMMARY

Embodiments disclosed herein address the above stated needs including, for example, one or more embodiments, in which methods, software and apparatus, are used to provide secure communications between client communication devices and servers. At least one embodiment includes generating a random offset. Such embodiment also includes altering a server communication device dynamic credential by applying the random offset to the server communication device dynamic credential. Such embodiment also includes storing the server communication device dynamic credential. The embodiment also includes sending, via a network, a signal including the random offset. The embodiment also includes receiving, via a network, a signal including a dynamic credential. Also, the embodiment includes determining a difference between the server communication device dynamic credential and the received dynamic credential. In addition, such embodiment also includes detecting a presence of a cloned communications device based on the difference.

At least one embodiment includes receiving, via a network, a signal including a random offset. Such embodiment also includes altering a client communication device dynamic credential by applying the random offset to the client communication device dynamic credential. In addition, such embodiment also includes sending, via the network, the altered client communication device dynamic credential.

At least one embodiment includes generating a random offset. Such embodiment also includes altering a server communication device dynamic credential by applying the random offset to the server communication device dynamic credential. Such embodiment also includes altering a server communication device dynamic credential by applying the random offset to the server communication device dynamic credential. Such embodiment also includes sending, via a network, a signal including the random offset. The embodiment also includes receiving, via a network, a signal including the random offset. The embodiment also includes altering a client communication device dynamic credential by applying the random offset to the client communication device dynamic credential. Further, the embodiment also includes sending, via the network, the altered client communication device dynamic credential. Also, such embodiment includes receiving, via a network, a signal including the altered client communication device dynamic credential. The embodiment also includes determining a difference between the server communication device dynamic credential and the altered client communication device dynamic credential. In addition, the embodiment also includes detecting a presence of a cloned communications device based on the difference.

At least one embodiment includes logic configured to generate a random offset. Such embodiment also includes logic configured to alter a server communication device dynamic credential by applying the random offset to the server communication device dynamic credential. The embodiment also includes logic configured to store the server communication device dynamic credential. The embodiment also includes logic configured to send, via a network, a signal including the random offset. The embodiment also includes logic configured to receive, via a network, a signal including a dynamic credential. Further, the embodiment includes logic configured to determine a difference between the server communication device dynamic credential and the received dynamic credential. In addition, the embodiment includes logic configured to detect a presence of a cloned communications device based on the difference.

At least one embodiment includes logic configured to receive, via a network, a signal including a random offset. Such embodiment also includes logic configured to alter a client communication device dynamic credential by applying the random offset to the client communication device dynamic credential. In addition, such embodiment includes logic configured to send, via the network, the altered client communication device dynamic credential.

At least one embodiment includes a server including logic configured to generate a random offset. Such embodiment also includes a server including logic configured to alter a server communication device dynamic credential by applying the random offset to the server communication device dynamic credential. Such embodiment also includes a server including logic configured to store the server communication device dynamic credential. The embodiment also includes a server including logic configured to send, via a network, a signal including the random offset. The embodiment also includes a server including logic configured to receive, via a network, a signal including a dynamic credential. The embodiment also includes a server including logic configured to determine a difference between the server communication device dynamic credential and the received dynamic credential. Further, the embodiment also includes a server including logic configured to detect a presence of a cloned communications device based on the difference. Such embodiment also includes a client communications device including logic configured to receive, via a network, the signal including the random offset. Such embodiment also includes a client communication device including logic configured to alter a client communication device dynamic credential by applying the random offset to the client communication device dynamic credential. In addition the embodiment also includes a client communication device including logic configured to send, via the network, the altered client communication device dynamic credential.

At least one embodiment includes code operable to generate a random offset. Such embodiment also includes code operable to alter a server communication device dynamic credential by applying the random offset to the server communication device dynamic credential. Such embodiment also includes code operable to store the server communication device dynamic credential. The embodiment also includes code operable to send, via a network, a signal including the random offset. The embodiment also includes code operable to receive, via a network, a signal including a dynamic credential. Further, the embodiment further includes code operable to determine a difference between the server communication device dynamic credential and the received dynamic credential. In addition, the embodiment includes code operable to detect a presence of a cloned communications device based on the difference.

At least one embodiment includes code operable to receive, via a network, a signal including a random offset. Such embodiment also includes code operable to alter a client communication device dynamic credential by applying the random offset to the client communication device dynamic credential. In addition, the embodiment includes code operable to send, via the network, the altered client communication device dynamic credential.

At least one embodiment includes code operable to generate a random offset. Such embodiment also includes code operable to alter a server communication device dynamic credential by applying the random offset to the server communication device dynamic credential. Such embodiment also includes code operable to store the server communication device dynamic credential. Such embodiment also includes code operable to send, via a network, a signal including the random offset. The embodiment also includes code operable to receive, via a network, a signal including the random offset. The embodiment also includes code operable to alter a client communication device dynamic credential by applying the random offset to the client communication device dynamic credential. The embodiment also includes code operable to send, via the network, the altered client communication device dynamic credential. The embodiment also includes code operable to receive, via a network, a signal including the altered client communication device dynamic credential. Further, the embodiment also includes code operable to determine a difference between the server communication device dynamic credential and the altered client communication device dynamic credential. In addition, the embodiment also includes code operable to detect a presence of a cloned communications device based on the difference.

At least one embodiment includes means for generating a random offset. Such embodiment also includes means for altering a server communication device dynamic credential by applying the random offset to the server communication device dynamic credential. Such embodiment also includes means for storing the server communication device dynamic credential. The embodiment also includes means for sending, via a network, a signal including the random offset. The embodiment also includes means for receiving, via a network, a signal including a dynamic credential. Further, the embodiment also includes means for determining a difference between the server communication device dynamic credential and the received dynamic credential. In addition, the embodiment includes means for detecting a presence of a cloned communications device based on the difference.

At least one embodiment includes means for receiving, via a network, a signal including a random offset. The embodiment also includes means for altering a client communication device dynamic credential by applying the random offset to the client communication device dynamic credential. In addition, the embodiment also includes means for sending, via the network, the altered client communication device dynamic credential.

At least one embodiment includes a server including means for generating a random offset. Such embodiment further including a server including means for altering a server communication device dynamic credential by applying the random offset to the server communication device dynamic credential. Such embodiment further including a server including means for storing the server communication device dynamic credential. Such embodiment further including a server including means for sending, via a network, a signal including the random offset. Such embodiment further including a server including means for receiving, via a network, a signal including a dynamic credential. Such embodiment further including a server including means for determining a difference between the server communication device dynamic credential and the received dynamic credential. Further, such embodiment further including a server including means for detecting a presence of a cloned communications device based on the difference. In addition, the embodiment also including a client communications device including means for receiving, via a network, a signal including the random offset. Such embodiment also including a client communications device including means for altering a client communication device dynamic credential by applying the random offset to the client communication device dynamic credential. In addition, the embodiment also including a client communications device including means for sending, via the network, the altered client communication device dynamic credential.

At least some advantages of at least one embodiment include operational advantages as compared to the operational shortcomings of traditional hash chain methods that may be used to detect handset cloning and client communication device spoofing. For example, at least one embodiment provides the advantage of a relatively lightweight, single round trip, client initiated scheme that offers protection against client spoofing or cloning, even in the case where the attacker is able to obtain access to all of the client communication device's credentials, including a snapshot of the entire client communication device environment. Another advantage is low processing and storage overhead requirements for the server. Here, the server does not have to perform any iterated hashing, and it also does not require storage of additional metadata to detect divergence. The use of the dynamic credential at the client side provides a history of the last “n” updates to the credential which provides inherent value. In contrast, hash chains would require that a client communications device would have to store the history of at least the number of hashes used each time or all of the resulting hash values themselves. In addition, another advantage is the small payload size where the information that is sent can be on the order of 1 to 8 bytes rather than much larger payload sizes associated with hash chain methods.

Other advantages of at least one embodiment include the ability to defeat replay attacks where a non-authorized device attempts to spew a multitude of signals in a relatively short amount of time. For example a cloned device may attempt to perform a burst of a multitude of signals all containing the copied credentials (e.g., static and dynamic credentials), but, as described in embodiments above, the proposed system operates to detect a divergence between a server communications device dynamic credential and the corresponding client communications device dynamic credential, and in so doing, is capable of identifying such a signal burst as an indication of the presence of a cloned device or the initiation of a replay based attack from a valid client that has been subsequently compromised. Among other advantages, this method of identifying a cloned device is an improvement over prior art schemes where such detection of a cloned device is performed in a single round trip scheme.

Other aspects, advantages, and features of the present invention will become apparent after review of the entire application, including the following sections: Brief Description of the Drawings, Detailed Description, and the Claims.

### BRIEF DESCRIPTION OF THE DRAWINGS

The foregoing aspects and the attendant advantages of the embodiments described herein will become more readily apparent by reference to the following detailed description when taken in conjunction with the accompanying drawings wherein:

FIG. 1 is a high level diagram of one embodiment of a system for secure communications between a client communication device and a server;

FIG. 2 is a semi-high level diagram of one embodiment of a system for secure communications between a client communication device and a server;

FIG. 3 is a flowchart illustrating one embodiment of a system for secure communications between a client communication device and a server;

FIG. 4 is a diagram illustrating one embodiment of a procedure using signals to achieve secure communications between a client communication device and a server;

FIG. 5 is a block diagram of one embodiment of a server as used in a system for secure communications between a client communication devices and the server;

FIG. 6 is a block diagram of one embodiment of a client communication device as used in a system for secure communications between the client communication devices and a server;

FIG. 7 is a flowchart illustrating one embodiment of a system for secure communications between a client communication device and a server; and

FIG. 8 is a flowchart illustrating one embodiment of a system for secure communications between a client communication device and a server.

### DETAILED DESCRIPTION

The word “exemplary” is used herein to mean “serving as an example, instance, or illustration.” Any embodiment described herein as “exemplary” is not necessarily to be construed as preferred or advantageous over other embodiments. Further, many embodiments are described in terms of sequences of actions to be performed by, for example, elements of a computing device. It will be recognized that various actions described herein could be performed by specific circuits (e.g., application specific integrated circuits (ASICs)), by program instructions being executed by one or more processors, or by a combination of both. Further, the embodiments described herein can additionally be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform a certain action or “code operable to” perform the described action.

The following detailed description describes methods, systems, software and apparatus used to provide secure communications between client communication devices and servers. In at least one embodiment a server generates a random offset, alters a dynamic credential by applying the random offset number to the dynamic credential, the server storing the dynamic credential and sending the random offset number to a client communication device, the client communications device alters a dynamic credential by applying the random offset number to the dynamic credential, the client communications device stores the altered dynamic credential, the client communications device sends the altered dynamic credential to the server, the server receiving the altered dynamic credential and determines a difference between its stored dynamic credential and the received dynamic credential, based on this different the server determines if a cloned device is present.

In one or more embodiments, the system used to provide secure communications between client communication devices and servers operates in conjunction with a runtime environment (API) executing on the computing device. One such runtime environment (API) is what is to be a new version of the Binary Runtime Environment for Wireless® (BREW®) software platform developed by QUALCOMM, Inc., of San Diego, Calif. In at least one embodiment in the following description, the system used to provide secure communications between client communication devices and servers is implemented on a computing device executing a runtime environment (API), such as the new version of the BREW® software platform. However, one or more embodiments of the system used to provide secure communications between client communication devices and servers are suitable for use with other types of runtime environments (APIs) that, for example, operate to control the execution of applications on wireless client communication devices.

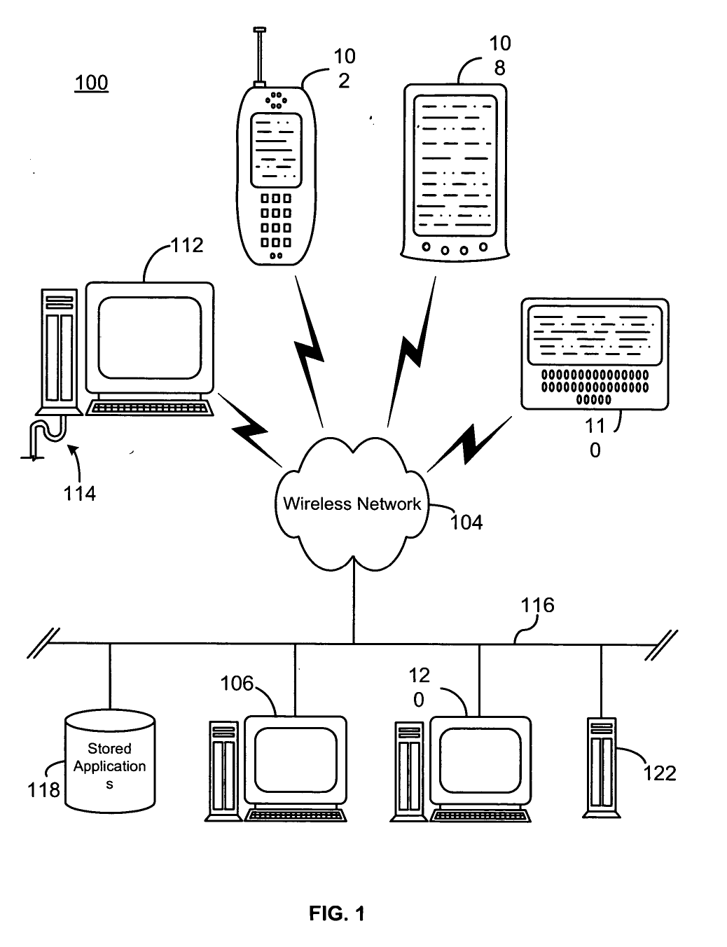

FIG. 1 illustrates a block diagram of one exemplary embodiment of system 100 for providing secure communications between client communication devices and servers, such as cellular telephone 102, in communication across a wireless network 104 with at least one application download server 106 that selectively transmits software applications and components to wireless devices across a wireless communication portal or other data access to the wireless network 104. As shown here, the wireless device can be a cellular telephone 102, a personal digital assistant 108, a pager 110, which is shown here as a two-way text pager, or even a separate computer platform 112 that has a wireless communication portal, and may otherwise have a wired connection 114 to a network or the Internet. The inventive system can thus be performed on any form of remote module including a wireless communication portal, including without limitation, wireless modems, PCMCIA cards, access terminals, personal computers, access terminals, telephones without a display or keypad, or any combination or sub-combination thereof.

The application download server 106 is shown here on a network 116 with other computer elements in communication with the wireless network 104. There is a second server 120 and a stand-alone server 122, and each server can provide separate services and processes to the wireless devices 102, 108, 110, 112 across the wireless network 104. There is preferably also at least one stored application database 118 that holds the software applications that are downloadable by the wireless devices 102, 108, 110, 112. Different embodiments are contemplated that locate logic to perform secure communications at any one or more of the application download server 106, second server 120 and stand-alone server 122.

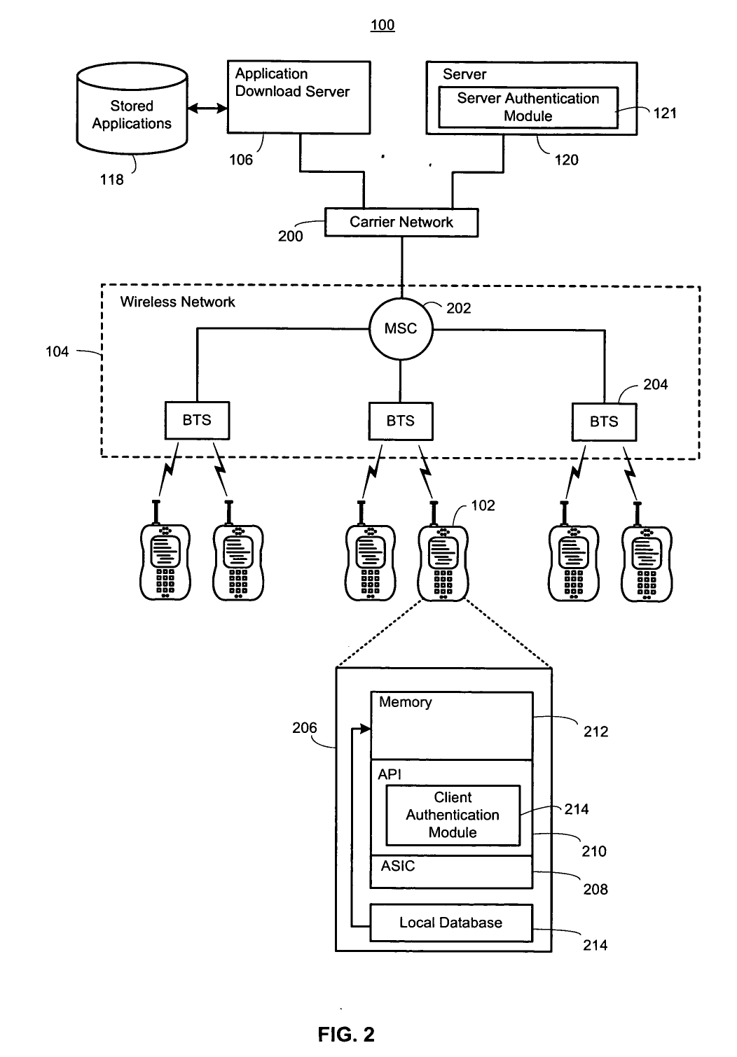

In FIG. 2, a block diagram is shown that more fully illustrates system 100, including the components of the wireless network 104 and interrelation of the elements of the exemplary embodiment. The system 100 is merely exemplary and can include any system whereby remote modules, such as wireless client communication devices 102, 108, 110, 112 communicate over-the-air between and among each other and/or between and among components connected via a wireless network 104, including, without limitation, wireless network carriers and/or servers. The application download server 106 and the stored application database 118, along with any other servers such as server 120 which are needed to provide cellular telecommunication services, communicate with a carrier network 200, through a data link, such as the Internet, a secure LAN, WAN, or other network. In the embodiment shown, the server 120 contains a server authentication module 121 containing logic configured to provide for secure communications over the carrier network 200. Such server authentication module 121 operates in conjunction with a client authentication module located on a client communication device, such as wireless devices 102, 108, 110, 112, to provide secure communications.

The carrier network 200 controls messages (sent as data packets) sent to a messaging service controller (“MSC”) 202. The carrier network 200 communicates with the MSC 202 by a network, the Internet and/or POTS (“plain ordinary telephone system”). Typically, the network or Internet connection between the carrier network 200 and the MSC 202 transfers data, and the POTS transfers voice information. The MSC 202 is connected to multiple base stations (“BTS”) 204. In a similar manner to the carrier network, the MSC 202 is typically connected to the BTS 204 by both the network and/or Internet for data transfer and POTS for voice information. The BTS 204 ultimately broadcasts messages wirelessly to the wireless devices, such as cellular telephone 102, by short messaging service (“SMS”), or other over-the-air methods known in the art.

The wireless device, (here a client communications device), such as cellular telephone 102, has a computer platform 206 that can receive and execute software applications transmitted from the application download server 106. The computer platform 206 includes an application-specific integrated circuit (“ASIC” 208), or other processor, microprocessor, logic circuit, or other data processing device. The ASIC 208 is installed at the time of manufacture of the wireless device and is not normally upgradeable. The ASIC 208 or other processor executes the application programming interface (“API”) 210 layer that interfaces with any resident programs in the memory 212 of the wireless device. The memory 212 can be comprised of read-only or random-access memory (RAM and ROM), EPROM, flash cards, or any memory common to computer platforms. The API 210 also includes a client authentication module 214 containing logic configured to provide for secure communications over the carrier network 200. Such client authentication module 214 operates in conjunction with a server authentication module 121 to provide secure communications. The computer platform 206 also includes a local database 214 that can hold applications not actively used in memory 212. The local database 216 is typically a flash memory cell, but can be any secondary storage device as known in the art, such as magnetic media, EPROM, optical media, tape, or soft or hard disk.

The wireless client communication device, such as cellular telephone 102, accordingly downloads one or more software applications, such as games, news, stock monitors, and the like, from the application download server 106 and holds the application on the local database 216 when not in use, and uploads stored resident applications on the local database 216 to memory 212 for execution on the API 210 when so desired by the user. Further, the communications over the wireless network 104 are performed in a secure manner, at least in part, because of the interaction and operation between the client authentication module 214 and the server authentication module 121. The present inventive system and method provides such secure communication over the wireless network 104, as is further described herein.

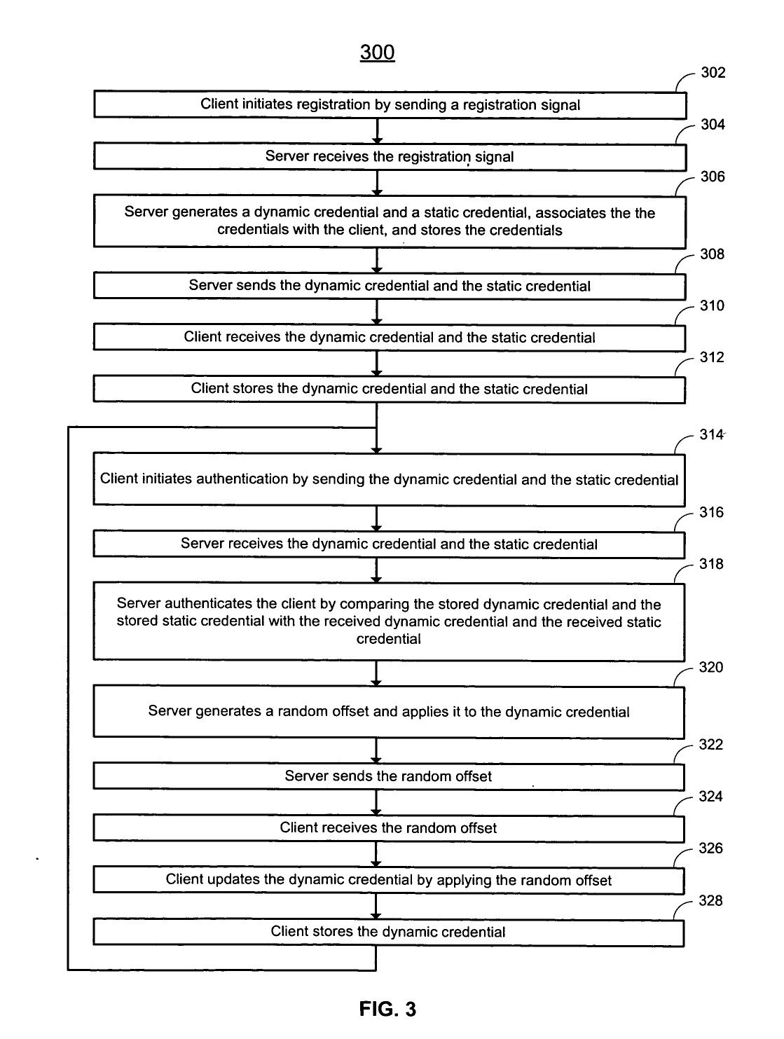

FIG. 3 illustrates one exemplary embodiment of a method 300 for providing secure communications. Method 300 begins with step 302 where a client communications device initiates registration with a remote server by sending a registration signal over a network. Next, in step 304, the server receives the registration signal. In step 306, the server generates both a dynamic credential and a static credential and associates the credentials with the remote client communications device. In the same step the server stores the credentials for future reference. The static credential is a credential that the server generates to identify the particular client device. Such static credential is expected in future signals sent by the client communications device to the server. The server uses the static credential by comparing the received static credential with the stored static credential to confirm that the signal received is actually from the particular client communications device.

The dynamic credential, although also capable of being used to identify the particular client communications device (i.e., signals therefrom), such dynamic credential is to be periodically altered or updated to increase secure communications capabilities. In one embodiment the dynamic credential is a number. Other embodiments utilize a dynamic credential that is another type of identifier other than a number, including, for example, an alpha character, symbol, control character, series of numbers, series of symbols, series of control characters, or a variety of other identifiers that are capable of being altered in a predictable and detectable manner. In one embodiment the dynamic credential is a series of binary bits. Different embodiments use different numbers of bits to represent the dynamic credential, such as 8 bits, 16 bits, 32 bits and 64 bits, although other embodiments use more or less numbers of bits. The amount of bits typically used is based less on security requirements and more on the amount of history to be tracked

In step 308 the server generates and sends a signal containing the dynamic credential and the static credential to the client device. This sending of a signal is also part of the registration step initiated in step 302. Although only two such credentials are shown being sent in step 308, other embodiments send additional credentials of varying types. Further, although not shown in the figure, other embodiments may also include the sending of an offset (random or otherwise) that may be used to alter the dynamic credential during the initial registration step. In response to the operations in step 308, the client communications device, in step 310, receives the signal containing the dynamic credential and the static credential. In step 312 the client communications device stores the dynamic credential and the static credential for use in future communications with the server. Here, step 312 represents the completion of the registration process.

With step 314 begins the sending of signals between the client communications device and the server where the credentials stored in the client communications device are included in signals sent the client communications device such that the server can authenticate such signals as coming from an authorized device. In response to step 314 server, in step 316, receives the sent signal containing the static and dynamic credentials as sent the client communications device. In step 318 the server operates to authenticate the signal by comparing the stored credentials at the server with the received credentials embedded in the received signal.

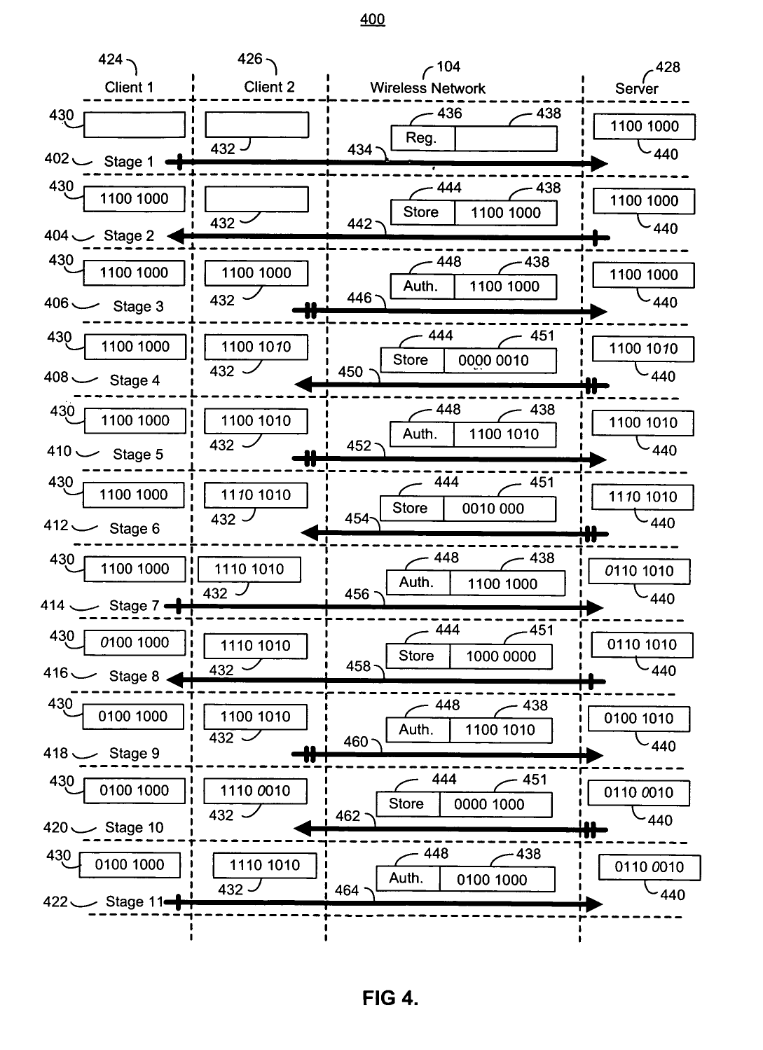

In the circumstance where the dynamic credential received from the client device does not match the dynamic credential stored at the server, the server may determine therefrom that there exists a cloned device of the original particular client communications device. Such may be determined because such an outcome may indicate that an updated dynamic credential was sent out to one device, believed to the particular client communications device, and another device that had a copy of an earlier version of the dynamic credential, sent out the old-non-updated dynamic credential attempting to mimic what it had copied at an earlier point in time from the actually authorized device. Other similar scenarios used to identify a cloned device are described in FIG. 4. Such operation complicates the work of a potential attacker. Even where the attacker is able to obtain an exact snapshot of a client device, for example, through physical access, through the use of malicious client software or by otherwise hacking into the registration process, such attacker must still provide the correct and updated version of the dynamic credential (which is constantly changing) or risk being identified as being a cloned device.

In some embodiments, the system operates such that not all discrepancies, where such discrepancies being between a dynamic credential stored at a server device and a received dynamic credential from a client communications device, represent the presence of a cloned device. Some embodiments operate such that expected loss of random offsets or other aspects of the system operation where occasionally, without the presence of a cloned device, certain circumstances occur that result in the divergence of the dynamic credential stored at a valid client communications device and the dynamic credential stored at the server. Some such embodiments expect to detect such divergent dynamic credential contents when, for example, a phone loses power, when communications signals are lost, or other scenarios where an intended update to a dynamic credential stored on a client device is not able to be executed for reasons other than the presence of a cloned device. In such embodiments, where divergent dynamic credentials are expected (tolerated) and processed, some such embodiments include a set tolerance for such a divergence and also allow the client communications device to re-synchronize itself with the server. The authentication operation described above includes the benefit of not requiring multiple round trips to detect an unauthorized device. Here the server is able to determine instantly when a single trip signal is received from a client communications device that contains a dynamic credential that does not match the dynamic credential stored on the server. This is true as the server does not monitor whether a client communications device successfully receives and processes a random offset and instead relies on the one-way detection of a divergence tolerance.

In the exemplary embodiment, a successive transmission from the server includes the sending of a random offset with a single bit set, and where such random offset is applied to the dynamic credential stored at the client device resulting in a Hamming Difference. In another embodiment, the random offset represents an identifier, (e.g., a number), that identifies which corresponding bit of the dynamic credential stored at the client device should be flipped. In such embodiment the random offset, which contains a number of the bit to flip, is applied to the dynamic credential stored at the client device resulting in a corresponding Hamming Difference. A Hamming Distance occurs where there is a number of divergent bits indicate and represents the number of bits, or other divergence measurement unit, from which the non-agreeing dynamic credentials differ. As such, this Hamming Distance information allows the system to determine when, or approximately when, the divergence started. Also in the exemplary embodiment, and unlike hash chain based schemes, the server need not store a long history of previous used hash values and then attempt to find a match for the value supplied by the client communications device. Here, the exemplary embodiment uses an algorithm based formula, (i.e., the flipping of one bit at a time), that produces an output such that the output can be evaluated to determine such information as when a divergent dynamic credential actually started.

In the circumstance where the server authenticates the signal as coming from an authorized source, the server, in step 320, generates a random offset and applies it to the stored dynamic credential. In the exemplary embodiment the dynamic credential and the random offset are 32 bit binary numbers. Also in such embodiment the random offset it a binary number represented with 32 bits where only one of such 32 bits set. In one embodiment the alteration of the dynamic credential using the random offset is performed by doing a bitwise “OR” on the two values. As such, consecutive alterations of the dynamic credential (with the flipping of one bit at a time) the system is able to determine the number of alterations based on how the altered dynamic credential compares to an original unaltered dynamic credential, including for example, the credential used in the initial registration process. Although some embodiments perform the alteration to the dynamic credential on each and every signal exchanged between the client communications device and the server, other embodiments, only perform such alterations periodically.

In step 322, the server sends the random offset to the client communications device. In response, in step 324, the client communications device receives the sent random offset. The client communications device, in step 326, updates the dynamic credential by applying the random offset. In step 328, the client communications device stores the sent dynamic credential for the purpose of including such dynamic credential in a future signal sent by the client communications device to the server.

FIG. 4 illustrates one embodiment 400 where a series of signal exchanges between multiple client communication devices and a server. As shown, a series of 11 stages describe one example of a set of signal exchanges, where such stages include: stage 1 402, stage 2 404, stage 3 406, stage 4 408, stage 5 410, stage 6 412, stage 7 414, stage 8 416, stage 9 418, stage 10 420, and stage 11 422. In addition, the illustration also shows a client 1 424, a client 2 426, a wireless network 104 and a server 428. In the illustration client 1 424 is meant to represent the authorized device where client 2 426 is meant to represent a cloned device of client 1 424.

Stage 1 402 represents an initial pre-registration state for both the clients as well as the server. Here, the client dynamic credential 430 of client 1 424 is shown as having no initial value, the same being true for the client dynamic credential 432 of client 2 426. The registration process begins with client 1 424 sending a signal 434 containing a registration command 436 and an empty dynamic credential value 438 to server 428. Sever 428 contains an initial server dynamic credential 440 of “1100 1000.” In response to receiving the signal 434 sent in stage 1 402, the system then performs the operation shown in stage 2 404.

Stage 2 404 shows the server 428 replying to the registration signal 434 sent by the client 1 424, where the server 428 maintains its server dynamic credential 440 of “1100 1000,” while sending a signal 442 including a copy of such server dynamic credential 440, along with a store command 444, to the client 1 424. Upon receipt of the signal 442 the client 1 424 operates to store the sent dynamic credential 440 as the client dynamic credential 430.

Stage 3 406 shows the client 2 426 (after cloning the contents of client 1) sending a signal 446 with an authenticate command 448 and a copy of the cloned client dynamic credential information of “1100 1000” 438 to server 428. The server, unaware of whether the signal came from client 1 424 or client 2 426, receives the signal 446 and authenticates the sent dynamic credential 438 with the stored server dynamic credential 440. Here, both the sent dynamic credential 438 and the server dynamic credential 440 match, so the server, in response, authenticates client 2 as a valid client communications device. Here, it is shown how a cloned device can be inaccurately identified by the server 428 as having sent a particular signal, but as further described below, the system operates to identify a clone generally, where in response, the system operates further to eliminate whichever client is the actual cloned device. In response to authenticating the signal 446, the system then performs the operations shown in stage 4 408.

Stage 4 408 shows the client 2 426 receiving a signal 450 containing a store command 444 and a random offset 451 “0000 0010.” Upon receipt of the signal 450 the client 2 applies the random offset 451 to the stored client dynamic credential shown in stage 3 406 to get the numeric result of the stored dynamic credential shown in state 4 408 of “1100 1010,” where, the italicized digit reflects the bit that was effected in response to alteration of the stored client dynamic credential. Note that the altered client credential is stored in the client communications device for future use by the client communications device.

In at least one embodiment the random offset 451 sent in signal 450 represents a binary number indicating the position of the bit to be flipped. For example, in one embodiment, the indication to flip a third bit of a corresponding stored dynamic credential would mean that the random offset 451 would include the binary representation for a base 10 “3” (“0000 0011”), and as such the system would operate to interpret the random offset contents of “0000 0011” as indicating a request to apply the random offset 451 to flip the third bit of a corresponding stored dynamic credential. In other embodiments the system is configured to interpret other formatting schemes of the random offset 451 to determine which one or more corresponding bits of a dynamic credential should be manipulated.

Stage 5 410 shows the client 2 426 sending a signal 452 with an authenticate command 448 and a copy of the client dynamic credential 432 to server 428. The server 428 receives the signal 452 and proceeds to authenticate the signal by successfully comparing the sent dynamic credential 438 with the stored server dynamic credential 440.

Stage 6 412 shows the client 2 426 receiving a signal 454 containing a store command 444 and a random offset 451 “0010 0000.” Upon receipt of the signal 454 the client 2 applies the random offset 451 to the stored client dynamic credential 432 shown in stage 5 410 to get the numeric result of the stored dynamic credential shown in stage 4 408 of “1110 1010,” where, the italicized digit reflects the bit that was effected in response to alteration of the stored client dynamic credential.

Stage 7 414 shows the client 1 424 (after having been cloned by client 2) sending a signal 456 with an authenticate command 448 and a copy of the original client dynamic credential information of “1100 1000” 438 to server 428. The server, unaware of whether the signal came from client 1 424 or client 2 426, receives the signal 456 and attempts an authentication of the sent dynamic credential 438 with the stored server dynamic credential 440. Here, the server 428 detects a mismatch of two separate bits, and therefrom determines that there is a strong likelihood that there is a divergence in the two previous authentications. Here, in one embodiment, the server 428 flags the client 1 424 as being either a clone or being cloned, while in another embodiment, the server 428 gives the client 1 424 another chance based on system policy. Examples of system policies include, for example, “allow a maximum of 3 consecutive mismatches (3 strikes and your out) before flagging a client communications device,” or “allow a maximum of 2 of the last 10 requests to be out of sync.” In the embodiment shown, the system, using a 3 strikes rule, gives the client 1 424 another chance and allows communications to continue.

Stage 8 416 shows the client 1 424 receiving a signal 458 containing a store command 444 and a random offset 451 “1000 0000.” Upon receipt of the signal 458 the client 1 424 applies the random offset 451 to the stored client dynamic credential 430 shown in stage 7 414 to get the numeric result of the stored dynamic credential shown in state 8 416 of “0100 1000,” where, the italicized digit reflects the bit that was effected in response to alteration of the stored client dynamic credential.

Stage 9 418 shows the client 2 426 sending a signal 460 with an authenticate command 448 and a copy of the client 2 426 client dynamic credential 432 to server 428. The server 428, unaware of whether the signal came from client 1 424 or client 2 426, receives the signal 460 and attempts an authentication of the sent dynamic credential 438 with the stored server dynamic credential 440. Here, the server 428 detects a mismatch of one bit, and because such a divergence is within the policy of the present embodiment, the server 428 identifies the signal as an authorized signal.

Stage 10 420 shows the client 2 426 receiving a signal 462 containing a store command 444 and a random offset 451 “0000 1000.” Upon receipt of the signal 462 the client 2 426 applies the random offset 451 to the stored client dynamic credential 432 shown in stage 9 418 to get the numeric result of the stored dynamic credential shown in stage 4 408 of “1110 0010,” where, the italicized digit reflects the bit that was effected in response to alteration of the stored client dynamic credential.

Stage 11 422 shows the client 1 424 sending a signal 464 with an authenticate command 448 and a copy of the client dynamic credential information of “0100 1000” 438 to server 428. The server, unaware of whether the signal came from client 1 424 or client 2 426, receives the signal 464 and attempts an authentication of the sent dynamic credential 438 with the stored server dynamic credential 440. Here, the server 428 detects a mismatch of three separate bits, (“0100 1000” vs. “0110 0010”) and therefrom determines that there is, based on a policy of 3 strikes (3 mismatched bits) and your out, a strong likelihood that at cloned devices exists. Here, the server 428 flags the client 1 424 as being either a clone or being cloned.

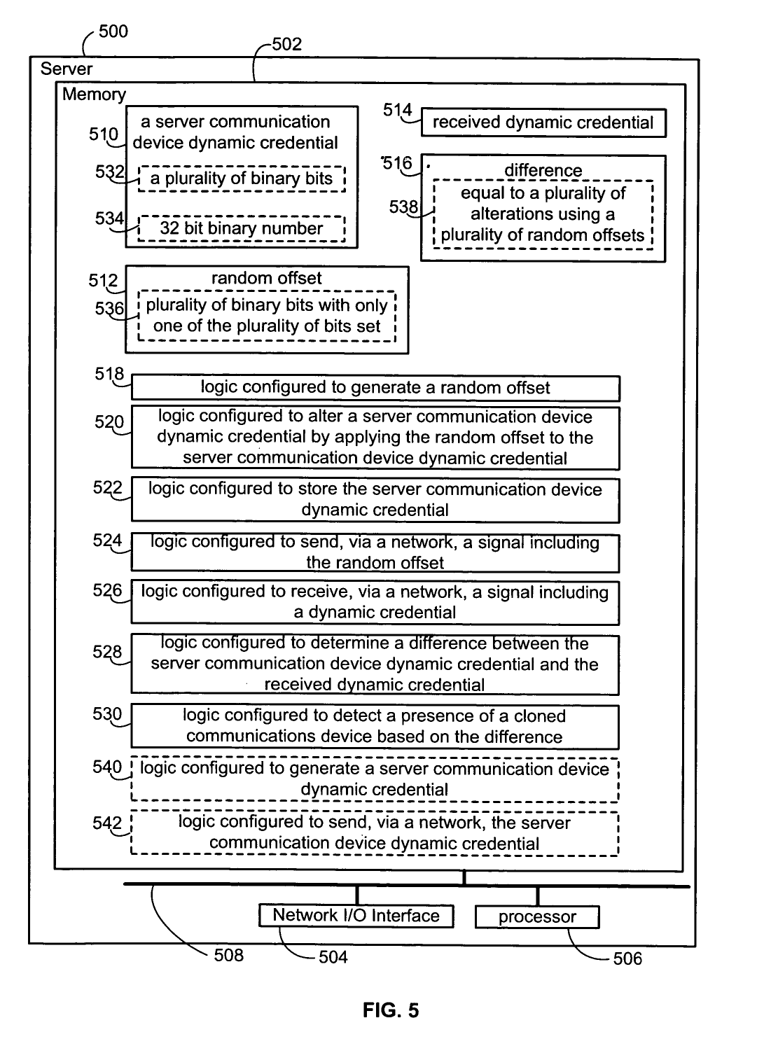

FIG. 5 illustrates one exemplary embodiment of a server 500 operable to perform secure communications with a client communications device. As used herein “server” includes, for example, logic executing on a communications device which provides a service to other logic executing on the same or separate communications device. In one embodiment, the server 500 includes logic operating on a separate communications device from a client communications device and is coupled to the client communications device over a network. In one embodiment such network is, at least in part, a wireless network 104. In at least one such embodiment the server 500 provides at least one dynamic credential to the client communications device in response to receiving a registration signal from the client communications device. In at least one embodiment the server 500 can be any of the servers 106, 120, 122 shown and described in relation to FIG. 1.

As shown in the exemplary embodiment, the server 500 includes memory 502, network I/O interface 504, processor 506 and bus 508. Although the memory 502 is shown as RAM memory, other embodiments include such memory 502 as all known types of memory that are known to provide for the storing of configured logic. In addition, although memory 502 is shown as one contiguous unit of one type of memory, other embodiments use multiple locations and multiple types of memory as memory 502. The network I/O interface 504 provides input and output to devices coupled to the network via the bus 508. The processor 506 operates on instructions and data provided via the bus 508.

Located in memory 502 is a server communication device dynamic credential 510, random offset 512, received dynamic credential 514, difference 516, logic 518 configured to generate a random offset 512, logic 520 configured to alter a server communication device dynamic credential 510 by applying the random offset 512 to the server communication device dynamic credential 510, logic 522 configured to store the server communication device dynamic credential 510, logic 524 configured to send, via a network, a signal including the random offset 512, logic 526 configured to receive, via a network, a signal including a dynamic credential 514, logic 528 configured to determine a difference 516 between the server communication device dynamic credential 510 and the received dynamic credential 514, and logic 530 configured to detect a presence of a cloned communications device based on the difference 516.

In at least one embodiment, the server communication device dynamic credential 510 includes a plurality of binary bits 532. In another embodiment the server communication device dynamic credential 510 includes a 32 bit binary number 534. Also, in one embodiment, the random offset 512 includes plurality of binary bits with only one of the plurality of bits set (536). Also, in one embodiment, the difference 516 is equal to a plurality of alterations using a plurality of random offsets 512 (538). Further, at least one embodiment includes the optional logic 540 configured to generate a server communication device dynamic credential 510. In addition, at least one embodiment includes the optional logic 542 configured to send, via a network, the server communication device dynamic credential 510.

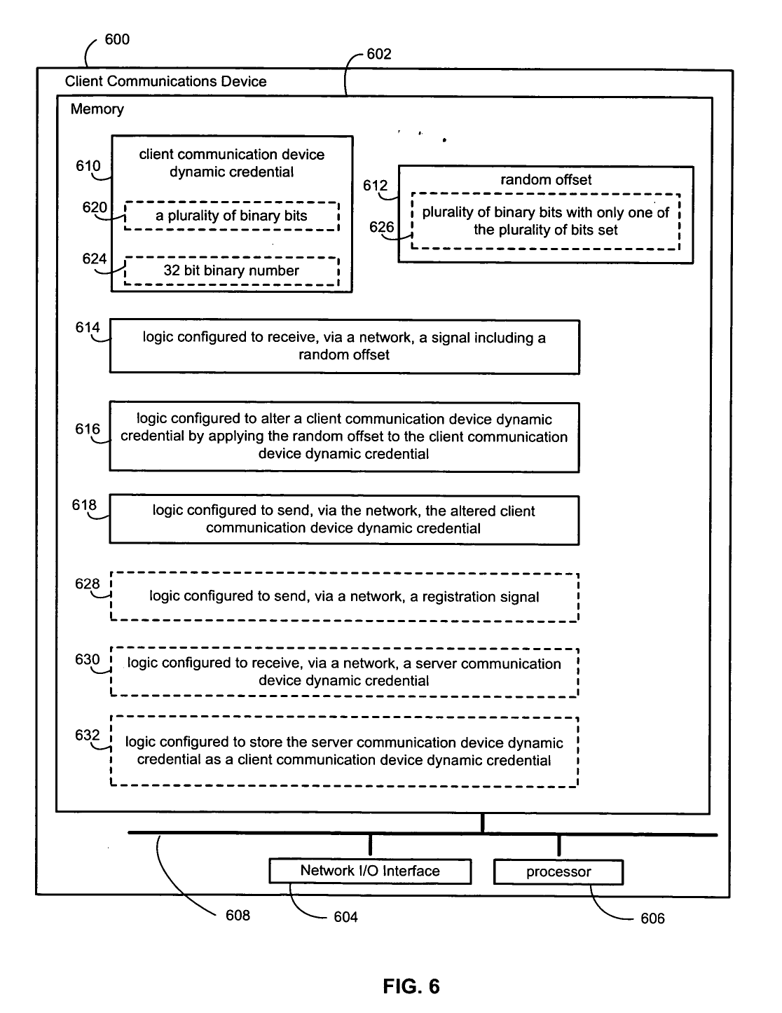

FIG. 6 illustrates one exemplary embodiment of a client communications device 600 operable to perform secure communications with a server. As used herein “client communications device” includes, for example, one or more processing circuits executing resident configured logic, where such computing devices include, for example, microprocessors, digital signal processors (DSPs), microcontrollers, portable wireless telephones, personal digital assistants (PDAs), and paging devices, or any suitable combination of hardware, software and/or firmware containing processors and logic configured to at least perform the operations described herein directed to secure communications. The client communications device 600 is serviced by at least one server (typically located remotely) with respect to at least such secure communications. In one embodiment such network is, at least in part, a wireless network 104. In at least one such embodiment the client communications device 600 receives at least one dynamic credential from the server in response to sending a registration signal from the client communications device 600. In at least one embodiment the client communications device 600 can be any of the wireless devices 102, 108, 110 and 112, shown and described in relation to FIG. 1.

As shown in the exemplary embodiment, the client communications device 600 includes memory 602, network I/O interface 604, processor 606 and bus 608. Although the memory 602 is shown as RAM memory, other embodiments include such memory 602 as all known types of memory that are known to provide for the storing of configured logic. In addition, although memory 602 is shown as one contiguous unit of one type of memory, other embodiments use multiple locations and multiple types of memory as memory 602. The network I/O interface 604 provides input and output to devices coupled to the network via the bus 608. The processor 606 operates on instructions and data provided via the bus 608.

Located in memory 602 is a client communication device dynamic credential 610, and random offset 612, logic 614 configured to receive, via a network, a signal including a random offset 612, logic 616 configured to alter a client communication device dynamic credential 610 by applying the random offset 612 to the client communication device dynamic credential 610, and logic 618 configured to send, via the network, the altered client communication device dynamic credential 610.

In at least one embodiment, the client communication device dynamic credential 610 includes a plurality of binary bits 620. In another embodiment the client communication device dynamic credential 610 includes a 32 bit binary number 624. Also, in one embodiment, the random offset 612 includes plurality of binary bits with only one of the plurality of bits set (626). Also, at least one embodiment includes the optional logic 628 configured to send, via a network, a registration signal. In addition, at least one embodiment includes the optional logic 630 configured to receive, via a network, a server communication device dynamic credential 510. In addition, at least one embodiment includes optional logic 632 configured to store the server communication device dynamic credential 510 as a client communication device dynamic credential 610.

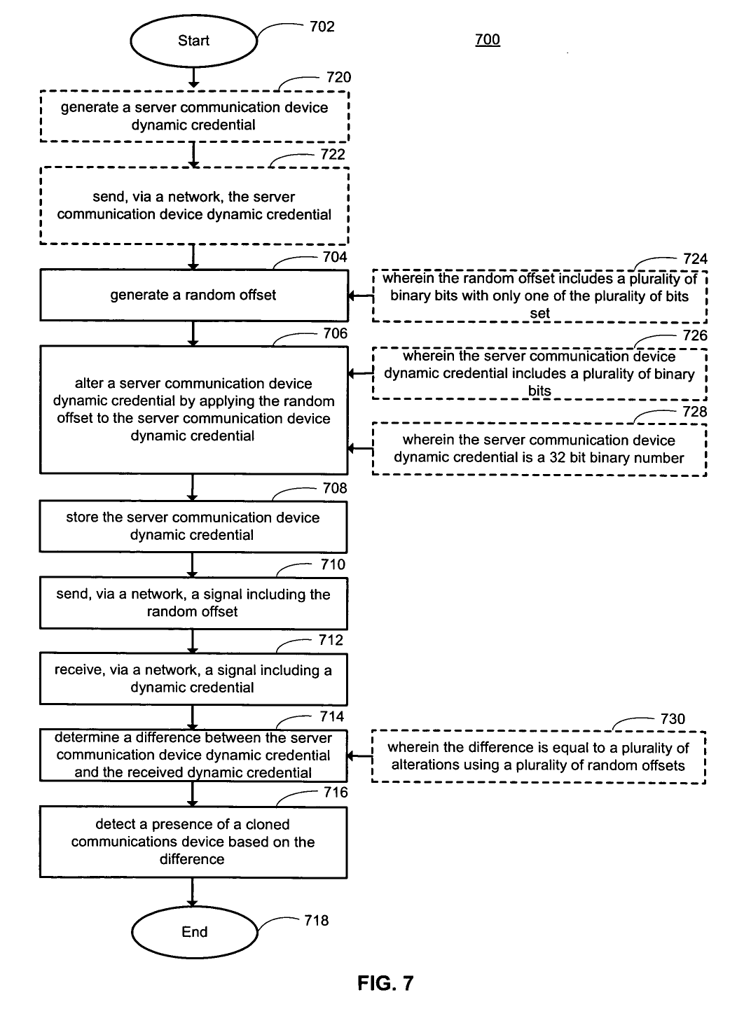

FIG. 7 illustrates one exemplary embodiment of a method 700 for providing secure communications. More specifically, method 700 is directed to the sending of a message containing a dynamic credential. Method 700 begins at start step 702 and continues with step 704 where the server 500 operates to generate a random offset 512. The method 700 also includes a step 706 where the server 500 operates to alter a server communication device dynamic credential 510 by applying the random offset 512 to the server communication device dynamic credential 510. Once the server communication device dynamic credential 510 has been altered, the server 500 operates, in step 708, to store the server communication device dynamic credential 510. Next, in step 710, the server 500 operates to send, via a network, a signal including the random offset 512. In response to the sending of the signal including the random offset 512, the server 500, in step 712, operates to receive, via a network, a signal including a dynamic credential. Once the signal including the dynamic credential 514 is received, the server 500 then operates to determine, in step 714, a difference 516 between the server communication device dynamic credential 510 and the received dynamic credential 514. Next, in response to the determination of step 714 yielding a difference 516 between the server communication device dynamic credential 510 and the received dynamic credential 514, the server 500 proceeds, in step 716, to detect a presence of a cloned communications device based on the difference 516.

In at least one embodiment, method 700 further includes optional step 720 in which the system further operates to generate a server communication device dynamic credential 510. In addition, other embodiments further include a step 722 in which the system further operates to send, via a network, the server communication device dynamic credential 510. Also, in at least one embodiment, step 704 is modified as shown in step 724 wherein the random offset 512 includes a plurality of binary bits with only one of the plurality of bits set (536). In addition, in at least one embodiment, step 706 is modified as shown in step 726 wherein the server communication device dynamic credential 510 includes a plurality of binary bits (532). In addition, in at least one embodiment, step 706 is modified as shown in step 728 wherein the server communication device dynamic credential 510 is a 32 bit binary number (534). In addition, in at least one embodiment, step 7114 is modified as shown in step 730 wherein the difference 516 is equal to a plurality of alterations using a plurality of random offsets.

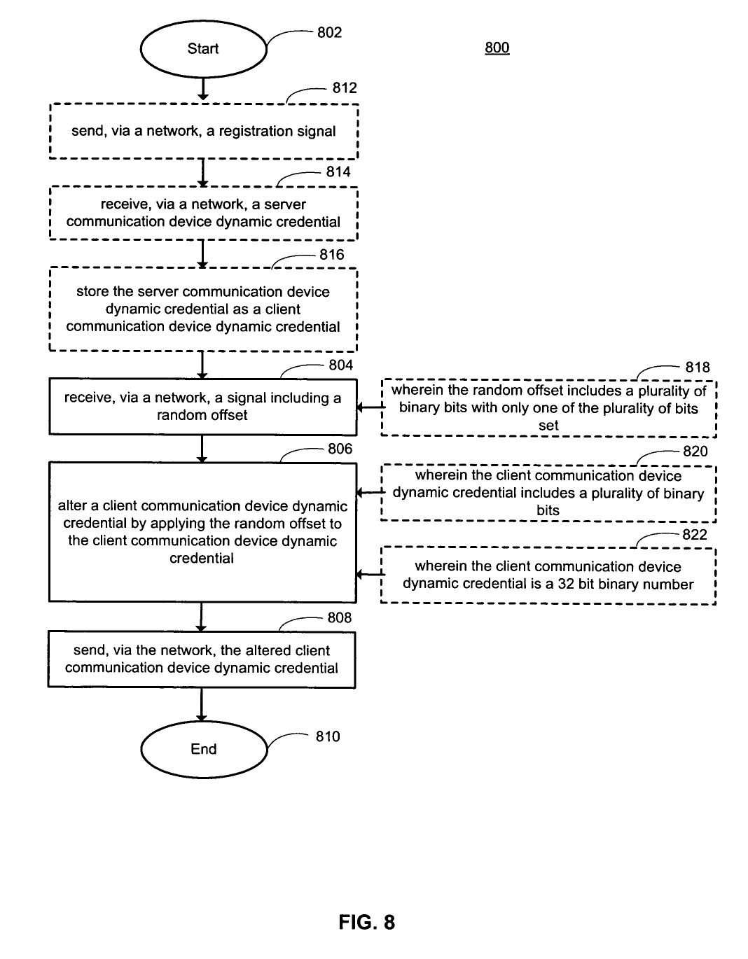

FIG. 8 illustrates one exemplary embodiment of a method 800 for providing secure communications. More specifically, method 800 is directed to the sending of a message containing a dynamic credential. Method 800 begins at start step 802 and continues with step 804 where a client communications device 600 operates receive, via a network, a signal including a random offset 612. The method 800 also includes a step 806 where the client communications device 600 operates to alter a client communication device dynamic credential 610 by applying the random offset 612 to the client communication device dynamic credential 610. Once the client communication device dynamic credential 610 has been altered, the client communication device 600 operates, in step 808, to send, via the network, the altered client communication device dynamic credential 600.

In at least one embodiment, method 800 further includes optional step 812 in which the system further operates to send, via a network, a registration signal. In addition, other embodiments further include a step 814 in which the system further operates to receive, via a network, a server communication device dynamic credential 510. Further, in at least one embodiment, a further step 816 is included in which the system operates to store the server communication device dynamic credential 510 as a client communication device dynamic credential 610. Also, in at least one embodiment, step 804 is modified as shown in step 818 wherein the random offset 612 includes a plurality of binary bits with only one of the plurality of bits set (626). In addition, in at least one embodiment, step 806 is modified as shown in step 820 wherein the client communication device dynamic credential 610 includes a plurality of binary bits (620). In addition, in at least one embodiment, step 806 is modified as shown in step 822 wherein the client communication device dynamic credential 610 is a 32 bit binary number (624).

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM memory, flash memory, ROM memory, PROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a computing device or user terminal. In the alternative, the processor and the storage medium may reside as discrete components in a computing device or user terminal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for detecting a cloned communications device, including:
generating a random offset;
altering a server communication device dynamic credential by applying the random offset to the server communication device dynamic credential;
storing the server communication device dynamic credential;
sending, via a network, a signal including the random offset;
receiving, via a network, a signal including a dynamic credential;
determining a difference between the server communication device dynamic credential and the received dynamic credential; and
detecting a presence of a cloned communications device based on the difference.

2. The method of claim 1, further including:
generating a server communication device dynamic credential; and
sending, via a network, the server communication device dynamic credential.

3. The method of claim 1, further including:
wherein the server communication device dynamic credential includes a plurality of binary bits; and
wherein the random offset includes a plurality of binary bits with only one of the plurality of bits set.

4. The method of claim 1, wherein the difference is equal to a plurality of alterations using a plurality of random offsets.

5. The method of claim 1, wherein the server communication device dynamic credential is a 32 bit binary number.

6. A method for detecting a cloned communications device, including:
receiving, via a network, a signal including a random offset;
altering a client communication device dynamic credential by applying the random offset to the client communication device dynamic credential; and
sending, via the network, the altered client communication device dynamic credential.

7. The method of claim 6, further including:
sending, via a network, a registration signal;
receiving, via a network, a server communication device dynamic credential; and
storing the server communication device dynamic credential as a client communication device dynamic credential.

8. The method of claim 6, further including:
wherein the client communication device dynamic credential includes a plurality of binary bits; and
wherein the random offset includes a plurality of binary bits with only one of the plurality of bits set.

9. The method of claim 6, wherein the client communication device dynamic credential is a 32 bit binary number.

10. A method for detecting a cloned communications device, including:
generating a random offset;
altering a server communication device dynamic credential by applying the random offset to the server communication device dynamic credential;
storing the server communication device dynamic credential;
sending, via a network, a signal including the random offset;
receiving, via a network, a signal including the random offset;
altering a client communication device dynamic credential by applying the random offset to the client communication device dynamic credential;
sending, via the network, the altered client communication device dynamic credential;
receiving, via a network, a signal including the altered client communication device dynamic credential;
determining a difference between the server communication device dynamic credential and the altered client communication device dynamic credential; and
detecting a presence of a cloned communications device based on the difference.

11. The method of claim 10, further including:
generating a server communication device dynamic credential;
sending, via a network, the server communication device dynamic credential;
sending, via a network, a registration signal;
receiving, via a network, the server communication device dynamic credential; and
storing the server communication device dynamic credential as a client communication device dynamic credential.

12. A server for detecting a cloned communications device, including:
logic configured to generate a random offset;
logic configured to alter a server communication device dynamic credential by applying the random offset to the server communication device dynamic credential;
logic configured to store the server communication device dynamic credential;
logic configured to send, via a network, a signal including the random offset;
logic configured to receive, via a network, a signal including a dynamic credential;
logic configured to determine a difference between the server communication device dynamic credential and the received dynamic credential; and
logic configured to detect a presence of a cloned communications device based on the difference.

13. The server of claim 12, further including:
logic configured to generate a server communication device dynamic credential; and
logic configured to send, via a network, the server communication device dynamic credential.

14. The server of claim 12, further including:
wherein the server communication device dynamic credential includes a plurality of binary bits; and
wherein the random offset includes a plurality of binary bits with only one of the plurality of bits set.

15. The server of claim 12, wherein the difference is equal to a plurality of alterations using a plurality of random offsets.

16. The server of claim 12, wherein the server communication device dynamic credential is a 32 bit binary number.

17. A client communications device operable in a system to detect a cloned communications device, including:
logic configured to receive, via a network, a signal including a random offset;
logic configured to alter a client communication device dynamic credential by applying the random offset to the client communication device dynamic credential; and
logic configured to send, via the network, the altered client communication device dynamic credential.

18. The client communications device of claim 17, further including:
logic configured to send, via a network, a registration signal;
logic configured to receive, via a network, a server communication device dynamic credential; and
logic configured to store the server communication device dynamic credential as a client communication device dynamic credential.

19. The client communications device of claim 17, further including:
wherein the client communication device dynamic credential includes a plurality of binary bits; and
wherein the random offset includes a plurality of binary bits with only one of the plurality of bits set.

20. The client communications device of claim 17, wherein the client communication device dynamic credential is a 32 bit binary number.

21. A system for detecting a cloned communications device, including:
a server including logic configured to:
generate a random offset;
alter a server communication device dynamic credential by applying the random offset to the server communication device dynamic credential;
store the server communication device dynamic credential;
send, via a network, a signal including the random offset;
receive, via a network, a signal including a dynamic credential;
determine a difference between the server communication device dynamic credential and the received dynamic credential; and
detect a presence of a cloned communications device based on the difference; and
a client communications device including logic configured to:
receive, via a network, the signal including the random offset;
alter a client communication device dynamic credential by applying the random offset to the client communication device dynamic credential; and
send, via the network, the altered client communication device dynamic credential.

22. The system of claim 21, wherein:
the server further including logic configured to:
generate a server communication device dynamic credential;
send, via a network, the server communication device dynamic credential;
the client communications device further including logic configured to:
send, via a network, a registration signal;
receive, via a network, the server communication device dynamic credential; and
store the server communication device dynamic credential as a client communication device dynamic credential.

23. A computer program embodied on a computer readable medium, the computer program capable of detecting a cloned communications device, the computer program comprising:
code operable to generate a random offset;
code operable to alter a server communication device dynamic credential by applying the random offset to the server communication device dynamic credential;
code operable to store the server communication device dynamic credential;
code operable to send, via a network, a signal including the random offset;
code operable to receive, via a network, a signal including a dynamic credential;
code operable to determine a difference between the server communication device dynamic credential and the received dynamic credential; and
code operable to detect a presence of a cloned communications device based on the difference.

24. The computer program of claim 23, further including:
code operable to generate a server communication device dynamic credential; and
code operable to send, via a network, the server communication device dynamic credential.

25. The computer program of claim 23, further including:
wherein the server communication device dynamic credential includes a plurality of binary bits; and
wherein the random offset includes a plurality of binary bits with only one of the plurality of bits set.

26. The computer program of claim 23, wherein the difference is equal to a plurality of alterations using a plurality of random offsets.

27. The computer program of claim 23, wherein the server communication device dynamic credential is a 32 bit binary number.

28. A computer program embodied on a computer readable medium, the computer program capable of altering a dynamic credential using a random offset, the computer program comprising:
code operable to receive, via a network, a signal including a random offset;
code operable to alter a client communication device dynamic credential by applying the random offset to the client communication device dynamic credential; and
code operable to send, via the network, the altered client communication device dynamic credential.

29. The computer program of claim 28, further including:
code operable to send, via a network, a registration signal;
code operable to receive, via a network, a server communication device dynamic credential; and
code operable to store the server communication device dynamic credential as a client communication device dynamic credential.

30. The computer program of claim 28, further including:
wherein the client communication device dynamic credential includes a plurality of binary bits; and
wherein the random offset includes a plurality of binary bits with only one of the plurality of bits set.

31. The computer program of claim 28, wherein the client communication device dynamic credential is a 32 bit binary number.

32. A computer program embodied on a computer readable medium, the computer program capable of detecting a cloned communications device, the computer program comprising:
code operable to generate a random offset;
code operable to alter a server communication device dynamic credential by applying the random offset to the server communication device dynamic credential;
code operable to store the server communication device dynamic credential;
code operable to send, via a network, a signal including the random offset;
code operable to receive, via a network, a signal including the random offset;
code operable to alter a client communication device dynamic credential by applying the random offset to the client communication device dynamic credential;
code operable to send, via the network, the altered client communication device dynamic credential;
code operable to receive, via a network, a signal including the altered client communication device dynamic credential;
code operable to determine a difference between the server communication device dynamic credential and the altered client communication device dynamic credential; and
code operable to detect a presence of a cloned communications device based on the difference.

33. The computer program of claim 32, further including:
generating a server communication device dynamic credential;
sending, via a network, the server communication device dynamic credential;
sending, via a network, a registration signal;
receiving, via a network, the server communication device dynamic credential; and
storing the server communication device dynamic credential as a client communication device dynamic credential.

34. A server for detecting a cloned communications device, including:
means for generating a random offset;
means for altering a server communication device dynamic credential by applying the random offset to the server communication device dynamic credential;
means for storing the server communication device dynamic credential;
means for sending, via a network, a signal including the random offset;
means for receiving, via a network, a signal including a dynamic credential;
means for determining a difference between the server communication device dynamic credential and the received dynamic credential; and
means for detecting a presence of a cloned communications device based on the difference.

35. The server of claim 34, further including:
means for generating a server communication device dynamic credential; and
means for sending, via a network, the server communication device dynamic credential.

36. The server of claim 34, further including:
wherein the server communication device dynamic credential includes a plurality of binary bits; and
wherein the random offset includes a plurality of binary bits with only one of the plurality of bits set.

37. The server of claim 34, wherein the difference is equal to a plurality of alterations using a plurality of random offsets.

38. The server of claim 34, wherein the server communication device dynamic credential is a 32 bit binary number.

39. A client communications device operable in a system to detect a cloned communications device, including:
means for receiving, via a network, a signal including a random offset;
means for altering a client communication device dynamic credential by applying the random offset to the client communication device dynamic credential; and
means for sending, via the network, the altered client communication device dynamic credential.

40. The client communications device of claim 39, further including:
means for sending, via a network, a registration signal;
means for receiving, via a network, a server communication device dynamic credential; and
means for storing the server communication device dynamic credential as a client communication device dynamic credential.

41. The client communications device of claim 39, further including:
wherein the client communication device dynamic credential includes a plurality of binary bits; and
wherein the random offset includes a plurality of binary bits with only one of the plurality of bits set.

42. The client communications device of claim 39, wherein the client communication device dynamic credential is a 32 bit binary number.

43. A system for detecting a cloned communications device, including:
a server including means for:
generating a random offset;
altering a server communication device dynamic credential by applying the random offset to the server communication device dynamic credential;
storing the server communication device dynamic credential;
sending, via a network, a signal including the random offset;
receiving, via a network, a signal including a dynamic credential;
determining a difference between the server communication device dynamic credential and the received dynamic credential; and
detecting a presence of a cloned communications device based on the difference; and
a client communications device including means for:
receiving, via a network, a signal including the random offset;
altering a client communication device dynamic credential by applying the random offset to the client communication device dynamic credential; and
sending, via the network, the altered client communication device dynamic credential.

44. The system of claim 43, wherein:
the server further including means for:
generating a server communication device dynamic credential;
sending, via a network, the server communication device dynamic credential;
the client communications device further including means for:
sending, via a network, a registration signal;
receiving, via a network, the server communication device dynamic credential; and
storing the server communication device dynamic credential as a client communication device dynamic credential.
